(19) United States
(12) Patent Application Publication
(10) Pub. No.: US 2022/0195287 A1
(43) Pub. Date: Jun. 23, 2022

(54) PEROVSKITE-BASED SCINTILLATOR AND METHODS OF USING THE SAME

(71) Applicant: UNIVERSITY OF VIRGINIA PATENT FOUNDATION, Charlottesville, VA (US)

(72) Inventors: Joshua J. CHOI, Charlottesville, VA (US); Matthew R. ALPERT, Charlottesville, VA (US); Seung-Hun LEE, Charlottesville, VA (US)

(73) Assignee: UNIVERSITY OF VIRGINIA PATENT FOUNDATION, Charlottesville, VA (US)

(21) Appl. No.: 17/604,158

(22) PCT Filed: Apr. 17, 2020
(86) PCT No.: PCT/US2020/028749

§ 371 Date: Oct. 15, 2021

Related U.S. Application Data
(60) Provisional application No. 62/836,180, filed on Apr. 19, 2019.

(51) Int. Cl. C09K 11/02; C09K 11/62; C09K 11/77; G01T 1/202

(52) U.S. Cl. CPC C09K 11/02; C09K 11/628; B82Y 20/00; C09K 11/7772; G01T 1/2023; C09K 11/7704

(57) ABSTRACT

A nanoparticle-in-perovskite (NIP) scintillator includes a host matrix and one or more nanoparticles embedded in the host matrix. The one or more nanoparticles are embedded in the host matrix at a loading volume of 20% or less. The host matrix has a thickness of 1 mm or greater. The host matrix is a polycrystalline perovskite material. In addition, the NIP scintillator is configured to exhibit a luminescent response to ionizing radiation having a photon energy of 1 keV or greater.

### CROSS-REFERENCE TO RELATED APPLICATION

This application is a National Phase Application of International Application No. PCT/US2020/028749, filed on Apr. 17, 2020 and depends from and claims the benefit of U.S. Provisional Application No. 62/836,180 filed Apr. 19, 2019, the entire contents of which are incorporated herein by reference.

### TECHNICAL FIELD

The present specification generally relates a scintillation system including a nanoparticle-in-perovskite (NIP) scintillator and methods of manufacturing NIP scintillators.

### BACKGROUND

High energy photons, such as x-rays and gamma (γ)-rays, are used in non-invasive, non-destructive image creation applications (in both the medical, industrial, and security fields) to probe the internal structure and/or composition of an object. This is due to the high penetration ability of the incident radiation where the amount of penetration/transmission of the incident radiation varies based on the density and/or composition of the material inside the object. In order to detect the difference in amount of penetration/transmission of the incident high energy radiation, a scintillator material can be employed. Scintillators, or scintillation materials, refer to materials that once impinged by ionizing radiation, emit photons in the ultraviolet to visible to near-infrared range of wavelengths. These materials are commonly used to detect radiation from γ-rays, x-rays, α-particles, β-particles, neutrons, protons, and/or electrons.

However, current scintillator materials have limitations. The inorganic materials typically used display hygroscopic properties where exposure to and absorption of moisture from the external environment can render the material ineffective. Additionally, many current scintillators use large single crystals, making the fabrication of these devices expensive and complicated and limits the number of detector geometries that are accessible for fabrication. Furthermore, detection efficiency of the emitted photons (i.e. the emission wavelengths that enable maximum/maximized detection efficiency) presents additional issues in deploying current scintillator materials in scintillator sensor/detector-coupled systems. Accordingly, a need exists for improved scintillators.

### SUMMARY

According to a first aspect of the present disclosure, a nanoparticle-in-perovskite (NIP) scintillator includes a host matrix and one or more nanoparticles embedded in the host matrix. The one or more nanoparticles are embedded in the host matrix at a loading volume of 20% or less. The host matrix has a thickness of 1 mm or greater. The host matrix is a polycrystalline perovskite material. In addition, the NIP scintillator is configured to exhibit a luminescent response to ionizing radiation having a photon energy of 1 keV or greater.

A second aspect includes the NIP scintillator of the first aspect, wherein the polycrystalline perovskite material of the host matrix comprises A₂MX₄, AMX₃, ANX₄, or BMX₄, wherein A is a monovalent cation, or a combination of monovalent cations, comprising Li, Na, K, Rb, Cs, Fr, organic amidine compounds, or primary, secondary, tertiary, or quaternary organic ammonium compounds comprising 1 to 15 carbons; B is a divalent cation, or a combination of divalent cations, comprising Mg, Co, Ca, Cd, Sr, Ba, organic amidine compounds, or primary, secondary, tertiary, or quaternary organic ammonium compounds comprising 1 to 15 carbons, M is a divalent metal cation, or a combination of divalent metal cations, comprising Pb, Sn, Cu, Ni, Co, Fe, Pd, Cd, Eu, Yb, or Ge, N is Bi, Sb, or a combination thereof, and X is a monovalent anion, or a combination of monovalent anions, comprising F, Cl, Br, I, SCN, CN, OCN, or BaF₄.

A third aspect includes the NIP scintillator of any of the previous aspects, wherein the NIP scintillator is configured to exhibit a luminescent response to ionizing radiation comprising a photon energy of 10 keV or greater.

A fourth aspect includes the NIP scintillator of any of the previous aspects, wherein the NIP scintillator is configured to exhibit a luminescent response to ionizing radiation comprising a photon energy of 10² keV or greater.

A fifth aspect includes the NIP scintillator of any of the previous aspects, wherein the host matrix comprises a thickness of 5 mm or greater.

A sixth aspect includes the NIP scintillator of any of the previous aspects, wherein the host matrix comprises a thickness of 1 cm or greater.

A seventh aspect includes the NIP scintillator of any of the previous aspects, wherein the one or more nanoparticles comprises at least one of PbS, PbSe, PbTe, PbSSe, PbSeTe, CdS, CdSe, CdTe, CdSSe, CdSeTe, ZnS, ZnSe, ZnTe, ZnO, InAs, InSb, InP, InGaAs, CuInS₂, CuInSe₂, CuInSSe, CuInP, CuO, CuO₂, TiO₂, SnS, SnSe, SnTe, SnSSe, SnSeTe, SnO₂, Si, Ge, HgTe, FeO, GaAs, GaN, GaP GaSb, GaPAs, Bi₂S₃, Bi₂Se₃, and Bi₂Te₃.

An eighth aspect includes the NIP scintillator of any of the previous aspects, wherein the one or more nanoparticles comprise PbX, where X comprises a chalcogenide.

A ninth aspect includes the NIP scintillator of any of the previous aspects, wherein the polycrystalline perovskite material of the host matrix comprises a methylammonium lead halide.

A tenth aspect includes the NIP scintillator of the ninth aspect, wherein the methylammonium lead halide comprises MAPbCl₃, MAPbI₃, or MAPbBr₃.

An eleventh aspect includes the NIP scintillator of any of the first through eighth aspects, wherein the polycrystalline perovskite material of the host matrix comprises a cesium lead halide.

A twelfth aspect includes the NIP scintillator of the eleventh aspect, wherein the cesium lead halide comprises CsPbCl₃, CsPbI₃, or CsPbBr₃.

A thirteenth aspect includes the NIP scintillator of any of the previous aspects, wherein the one or more nanoparticles comprise a maximum cross-sectional dimension in a range of from 2 nm to 10 nm.

A fourteenth aspect includes the NIP scintillator of any of the previous aspects, wherein the one or more nanoparticles are embedded in the host matrix at a loading volume of 2% or less.

A fifteenth aspect includes the NIP scintillator of any of the previous aspects, wherein the luminescent response to ionizing radiation comprises an emission peak wavelength of from 300 nm to 1500 nm.

A sixteenth aspect includes the NIP scintillator of any of the previous aspects, wherein the luminescent response to ionizing radiation comprises a scintillation efficiency of 1% or greater.

According to a seventeenth aspect, a method of manufacturing an NIP scintillator includes applying pressure to a composite powder mixture that includes a polycrystalline perovskite powder mixed with nanoparticle powder thereby pressing the composite powder mixture into a wafer having a thickness of 1 mm or greater, where the wafer includes a host matrix of polycrystalline perovskite material having one or more nanoparticles embedded in the host matrix at a loading volume of 20% or less.

An eighteenth aspect includes the method of the seventeenth aspect, further comprising dispersing a nanoparticle precursor in a perovskite precursor solution via a ligand exchange process to form the composite powder mixture prior to applying pressure to the composite powder mixture.

A nineteenth aspect includes the method of the eighteenth aspect, wherein the nanoparticle precursor is formed by a hot injection method.

A twentieth aspect includes the method of any of the seventeenth through nineteenth aspects, wherein the thickness of the wafer is 1 cm or greater.

A twenty-first aspect includes the method of any of the seventeenth through twentieth aspects, wherein the NIP scintillator is configured to exhibit a luminescent response to electromagnetic radiation comprising a photon energy of 1 keV or greater.

A twenty-second aspect includes the method of any of the seventeenth through twenty-first aspects, wherein the NIP scintillator is configured to exhibit a luminescent response to electromagnetic radiation comprising a photon energy of 10² keV or greater.

A twenty-third aspect includes the method of any of the seventeenth through twenty-second aspects, wherein the polycrystalline perovskite material of the host matrix comprises A₂MX₄, AMX₃, ANX₄, or BMX₄, wherein: A is a monovalent cation, or a combination of monovalent cations, comprising Li, Na, K, Rb, Cs, Fr, organic amidine compounds, or primary, secondary, tertiary, or quaternary organic ammonium compounds comprising 1 to 15 carbons; B is a divalent cation, or a combination of divalent cations, comprising Mg, Co, Ca, Cd, Sr, Ba, organic amidine compounds, or primary, secondary, tertiary, or quaternary organic ammonium compounds comprising 1 to 15 carbons, M is a divalent metal cation, or a combination of divalent metal cations, comprising Pb, Sn, Cu, Ni, Co, Fe, Pd, Cd, Eu, Yb, or Ge, N is Bi, Sb, or a combination thereof, and X is a monovalent anion, or a combination of monovalent anions, comprising F, Cl, Br, I, SCN, CN, OCN, or BaF₄.

A twenty-fourth aspect includes the method of any of the seventeenth through twenty-third aspects, wherein the polycrystalline perovskite material of the host matrix comprises a methylammonium lead halide or a cesium lead halide and the one or more nanoparticles comprise PbX, where X comprises a chalcogenide.

According to a twenty-fifth aspect, a method of outputting scintillated radiation includes receiving ionizing radiation with a photon energy of 1 keV or greater using an NIP scintillator having one or more nanoparticles embedded in a host matrix at a loading volume of 20% or less, where the host matrix is a polycrystalline perovskite. The method further includes absorbing the ionizing radiation in the host matrix thereby inducing emission of scintillated radiation from at least one of the one or more nanoparticles and outputting scintillated radiation from the NIP scintillator comprising a scintillation efficiency of 1% or greater.

A twenty-sixth aspect includes the method of the twenty-fifth aspect, wherein the host matrix comprises a thickness of 1 mm or greater.

A twenty-seventh aspect includes the method of the twenty fifth aspect or the twenty-sixth aspect, wherein the host matrix comprises a thickness of 1 cm or greater.

A twenty-eighth aspect includes the method of any of the twenty-fifth through the twenty-seventh aspect, wherein the ionizing radiation comprises a photon energy of 10² keV or greater.

A twenty-ninth aspect includes the method of any of the twenty-fifth through the twenty-eighth aspects, wherein the ionizing radiation comprises a photon energy of 10⁴ keV or greater.

A thirtieth aspect includes the method of any of the twenty-fifth through the twenty-ninth aspects, wherein the polycrystalline perovskite material of the host matrix comprises A₂MX₄, AMX₃, ANX₄, or BMX₄, wherein: A is a monovalent cation, or a combination of monovalent cations, comprising Li, Na, K, Rb, Cs, Fr, organic amidine compounds, or primary, secondary, tertiary, or quaternary organic ammonium compounds comprising 1 to 15 carbons; B is a divalent cation, or a combination of divalent cations, comprising Mg, Co, Ca, Cd, Sr, Ba, organic amidine compounds, or primary, secondary, tertiary, or quaternary organic ammonium compounds comprising 1 to 15 carbons, M is a divalent metal cation, or a combination of divalent metal cations, comprising Pb, Sn, Cu, Ni, Co, Fe, Pd, Cd, Eu, Yb, or Ge, N is Bi, Sb, or a combination thereof, and X is a monovalent anion, or a combination of monovalent anions, comprising F, Cl, Br, I, SCN, CN, OCN, or BaF₄.

A thirty-first aspect includes the method of any of the twenty-fifth through the thirtieth aspects, wherein the polycrystalline perovskite material of the host matrix comprises a methylammonium lead halide or a cesium lead halide and the one or more nanoparticles comprise PbX, where X comprises a chalcogenide.

A thirty-second aspect includes the method of any of the twenty-fifth through the thirty-first aspects, wherein the one or more nanoparticles are embedded in the host matrix at a loading volume of 2% or less.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a scintillator system comprising an NIP scintillator having one or more nanoparticles embedded in a host matrix and a photodetector array optically coupled to the NIP scintillator, according to one or more embodiments shown and described herein;

FIG. 2 graphically depicts total attenuation length as a function of photon energy of stimulating radiation for NIP scintillators having four example host matrix materials, according to one or more embodiments shown and described herein;

FIG. 3 graphically depicts emission wavelength as a function of diameter for PbS nanoparticles embedded in a host matrix of an NIP scintillator, according to one or more embodiments shown and described herein;

FIG. 4 graphically depicts bandgap energy for six example host matrixes and an example nanoparticle, according to one or more embodiments shown and described herein;

FIG. 5 graphically depicts absorbance and photo-luminescent intensity as a function of wavelength for a NIP scintillator comprising an MAPbBr₃ host matrix and PbS nanoparticles, according to one or more embodiments shown and described herein; and

FIG. 6 graphically depicts photo-luminescent intensity as a function of wavelength for example NIP scintillators formed using a variety of techniques, according to one or more embodiments shown and described herein.

### DETAILED DESCRIPTION

Referring generally to the figures, embodiments of the present disclosure are directed to scintillation systems that include scintillators with a nanoparticle-in-perovskite (NIP) structure. The present disclosure is also directed to methods of manufacturing NIP scintillators and methods of using NIP scintillators for converting ionizing radiation (e.g., vacuum ultra violet (VUV), x-ray, and/or γ-ray radiation) into scintillated radiation (e.g., radiation having ultraviolet to visible to near-infrared range of wavelengths). Previous photodetectors for ionizing radiation have a number of limitations, including smaller carrier diffusion lengths than the material thickness necessary for sufficient absorption of the incident radiation. While current inorganic scintillator devices overcome this drawback and offer superior performance with x-rays and γ-rays, these inorganic scintillators still suffer their own drawbacks. For example, current inorganic scintillators are formed by growing large single crystals, which are sensitive to defects and have a complex and intricate fabrication process that is difficult to reproduce at large scale. Another drawback for current inorganic scintillators is they tend to emit in the UV to near blue wavelength regions, which is not well suited for silicon (Si) photodetectors, such as charged coupled devices (CCD), which have improved time resolution, better photon counting capabilities, lower cost, and better portability options. However, the NIP scintillator of the present disclosure mitigates many of these drawbacks and may be may be processed in powder form to accommodate a wide array of sizes and thicknesses. Furthermore, the NIP scintillator of the present disclosure has environmental and radiation stability, scintillates in wavelength regimes that are optimized for many different photodetectors, such as Si photodetectors, and provides increased detection sensitivity. Embodiments of scintillator systems and NIP scintillators will now be described and, whenever possible, the same reference numerals will be used throughout the drawings to refer to the same or like parts.

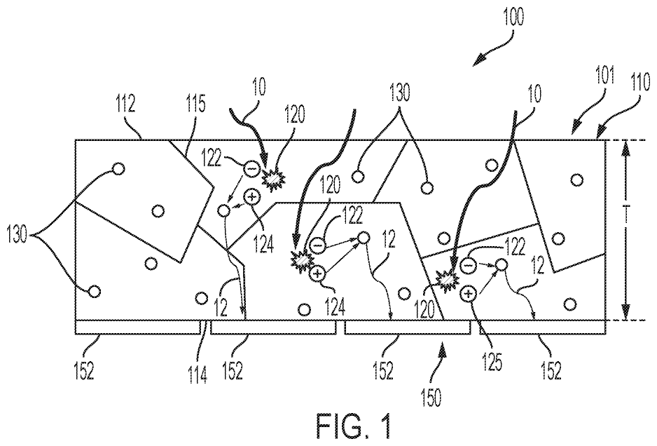

Referring now to FIG. 1, a scintillator system 100 comprising an NIP scintillator 101 optically coupled to one or more photodetectors 152 is schematically depicted. The NIP scintillator 101 comprises a host matrix 110 and one or more nanoparticles 130 embedded in the host matrix 110. The nanoparticles 130 comprise crystalline or polycrystalline particles having a maximum cross-sectional dimension (e.g., diameter in spherical embodiments) of from 1 nm to 100 μm. The host matrix 110 comprises a base material configured to absorb ionizing radiation 10 (depicted as absorption event 120), thereby generating photo-generated charges 122, 124. The host matrix 110 may be stimulated by ionizing radiation formed by electrons, protons, neutrons, α-particles, and/or β-particles. The one or more nanoparticles 130 operate as emission centers for emitting scintillated radiation 12 (i.e., luminescent response) at emission wavelengths ranging from the ultra violet range to the near-infrared range, for example, upon receipt of the photo-generated charges 122, 124 generated by the ionizing radiation 10.

The host matrix 110 comprises a first surface 112 opposite a second surface 114 and a thickness T measured from the first surface 112 to the second surface 114. The thickness T of the host matrix 110 may be 0.1 mm or greater, such as 0.5 mm or greater, 1 mm or greater, 2 mm or greater, 4 mm or greater, 5 mm or greater, 1 cm or greater, 2 cm or greater, 5 cm or greater, or the like, such as from 0.1 mm to 20 cm, such as from 0.5 mm to 20 cm, from 0.5 mm to 10 cm, from 1 mm to 10 cm, from 1 mm to 5 cm, from 1 mm to 1 cm, or the like. In some embodiments, ionizing radiation 10 is received by the NIP scintillator 101 at the first surface 112 and scintillated radiation 12 generated by interaction of the ionizing radiation 10 with the NIP scintillator 101 is output through the second surface 114, which may be optically coupled to the one or more photodetectors 152. In some embodiments, the NIP scintillator 101 is a wafer. However, it should be understood that other shapes are contemplated, such as a pellet or film.

By absorbing ionizing radiation 10 with the host matrix 110 and utilizing nanoparticles 130 as the emission centers for generating scintillated radiation 12, the absorption and emission processes are separated into two materials. This allows for independent control over the absorption and emission process. Indeed, utilizing nanoparticles 130 as emission centers allows for control over the emission properties of the NIP scintillator 101 due to size and composition-dependent optical properties of the nanoparticles 130.

In operation, the NIP scintillator 101 is configured to convert a wide range of energy regimes (i.e., a wide wavelength and energy range of ionizing radiation 10 into scintillated radiation 12 comprising visible to near-infrared light. In other words, the NIP scintillator 101 down converts the ionizing radiation 10 into scintillated radiation 12. While the NIP scintillator 101 can convert any ionizing radiation into scintillated radiation 12, it has the ability to down convert high energy ionizing radiation 10 to scintillated radiation 10, such as x-rays and γ-rays. For example, the NIP scintillator 10 is configured to exhibit a luminescent response to ionizing radiation comprising a photon energy of 1 keV or greater, such as 5 keV or great, 10 keV or greater, 25 keV or greater, 50 keV or greater, 75 keV or greater, 10² keV or greater, 10³ keV or greater, 10⁴ keV or greater, or the like. Furthermore, this luminescent response (i.e., scintillated radiation 12) generated by the NIP scintillator 10 in response to receiving this high energy ionizing radiation is more than a mere nominal response and thus comprises a scintillation efficiency of 1% or greater, where “scintillation efficiency” is (energy of the scintillated radiation)/(energy deposited by the ionizing radiation). In some embodiments, the scintillation efficiency is 5% or greater, 10% or greater, 25% or greater, 40% or greater, or the like.

The host matrix 110 may comprise a semiconductor material, an insulator material, or a combination thereof. In some embodiments, the host matrix 110 comprises a perovskite material, such as a polycrystalline perovskite material. When the host matrix 110 comprises a polycrystalline material, individual crystallites meet at grain boundaries 115. In these embodiments, photo-generated charges 122, 124 caused by the absorption of ionizing radiation 10 do not have to cross a grain boundary 115 to reach a nanoparticle 130. Without intending to be limited by theory, higher rates of non-radiative charge trapping occur at the grain boundaries 115, which reduces the overall performance. Additionally, the nanoparticles 130 may be homogenously distributed in the host matrix 110 (that is, have 10% or less distribution variation of nanoparticles volume throughout the NIP scintillator 101). By homogenously distributing the nanoparticles 130, the distance between an absorption event 120 and an individual nanoparticle 130 will remain fairly consistent, such that the photo-generated charges 122, 124 can reach a nanoparticle 130 efficiently over a short diffusion length without crossing a grain boundary 115. This increases the efficiency of converting the photo-generated charges 122, 124 into scintillated radiation 12 and reduces non-radiative losses.

In some embodiments, the polycrystalline perovskite material of the host matrix 110 comprises a composition of A₂MX₄, AMX₃, ANX₄, or BMX₄ where A is a monovalent cation, or a combination of monovalent cations, comprising Li, Na, K, Rb, Cs, Fr, organic amidine compounds, or primary, secondary, tertiary, or quaternary organic ammonium compounds containing 1 to 15 carbons, B is a divalent cation, or a combination of divalent cations, comprising Mg, Co, Ca, Cd, Sr, Ba, organic amidine compounds, or primary, secondary, tertiary, or quaternary organic ammonium compounds containing 1 to 15 carbons, M is divalent metal cation, or a combination of divalent metal cations, comprising Pb, Sn, Cu, Ni, Co, Fe, Pd, Cd, Eu, Yb, or Ge, N comprises Bi, Sb, or a combination thereof, and X is a monovalent anion, or a combination of monovalent anions, comprising F, Cl, Br, I, SCN, CN, OCN, or BaF₄. In other embodiments, the host matrix 110 may comprise other semiconductor materials, such as, CdS, CdSe, CdTe, NaI, CsI, LiI, CaF₂, BaF₂, CeF₃, LaCl₃, LaBr₃, ZnO, LuI₃, CdWO₄, PbWO₄, YVO₄, or other garnet materials, or a combination of multiple materials.

Some example polycrystalline perovskite materials that may form the host matrix 110 include methylammonium lead halides and cesium lead halides. For example, the host matrix 110 may comprise methylammonium lead chloride (MAPbCl₃), methylammonium lead iodine (MAPbI₃), methylammonium lead bromide (MAPbBr₃), cesium lead chloride (CsPbCl₃), cesium lead bromide (CsPbBr₃), and methylammonium lead iodine lead iodine (CsPbI₃). Each of these six example polycrystalline perovskite materials include Pb. Without intending to be limited by theory, Pb contains a large amount of high atomic number (Z) atoms and thus using a Pb-based perovskite as the host matrix 110 facilitates efficient absorption of high-energy ionizing radiation. Methylammonium lead halide (MAPbX₃) perovskites have excellent high energy absorption properties (i.e., a high absorption coefficient), have a high sensitivity to x-ray and γ-ray ionizing radiation, and are efficient at converting the absorbed photons into charge carriers (i.e., photo-generated charges) as they have a high estimated yield of charge carriers (i.e., photo-generated charges) per incident photon. In polycrystalline form, MAPbX₃ perovskites also have a high defect tolerance.

Some of these performance improvements offered by MAPbX₃ polycrystalline perovskites are shown in Table 1, below. In particular, Table 1 shows the estimated light yield per incident photon of three inorganic scintillator materials (NaI:Tl, LaBr₃:Tl, and LuI₃:Ce) and two NIP scintillators having MAPbX₃ polycrystalline perovskites forming their host matrix. The MAPbX₃ polycrystalline perovskites have a high sensitivity to even high energy γ-rays.

TABLE 1

| Material | Calculated Light Yield (photons/MeV) |
|---|---|
| NaI:Tl | 40,000 |
| LaBr₃:Tl | 68,000 |
| LuI₃:Ce | 100,000 |
| MAPbBr₃ | 190,000 |
| MAPbI₃ | 270,000 |

The polycrystalline perovskite material of the host matrix 110 may also increase the total attenuation length of the NIP scintillator 101 for higher energy ionizing radiation 10. As used herein, total attenuation length refers to the average distance into the NIP scintillator 101 ionizing radiation 10 of particular photon energy propagates before being absorbed by the host matrix 110 of the NIP scintillator 101. Without intending to be limited by theory, the total attenuation length of the NIP scintillator 101 increases for ionizing radiation 10 with increased photon energy.

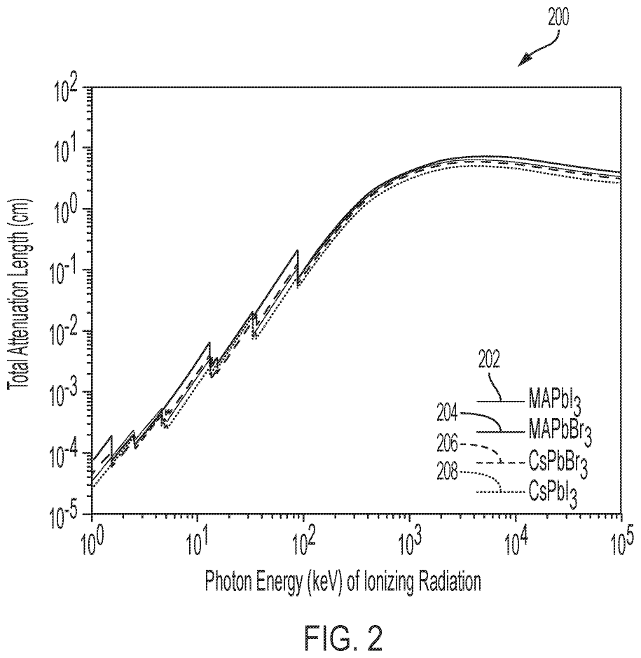

Referring now to FIG. 2, the total attenuation length of four example NIP scintillators 101 as a function of photon energy of the ionizing radiation 10 received by each NIP scintillator 101 is depicted. In particular, graph 200 of FIG. 2 includes line 202 showing the total attenuation length of an NIP scintillator having a host matrix comprising MAPbI₃, line 204 showing the total attenuation length of an NIP scintillator having a host matrix comprising MAPbBr₃, line 206 showing the total attenuation length of an NIP scintillator having a host matrix comprising CsPbBr₃, and line 208 showing the total attenuation length of an NIP scintillator having a host matrix comprising CsPbI₃. Graph 200 shows that photon energies of about 10² keV and greater (which includes x-ray and γ-ray ionizing radiation) have an attenuation length of about 1 mm or greater. As described above, the host matrix 110 of the NIP scintillator 101 may comprise a thickness T of about 1 mm or greater, for example, 1 cm or greater, and thus comprises a thickness T sufficient to absorb x-ray and γ-ray ionizing radiation. As described in more detail below, the thickness T may be achieved by the method of manufacturing the NIP scintillator 101 from a composite powder mixture to form the host matrix 110 and embedded nanoparticles 130.

Referring again to FIG. 1, the nanoparticles 130 may be isotropic or anisotropic in shape, including but not limited to, spheroids, rods, wires, cubes, disks, plates, or tetrapods. Further, the nanoparticles 130 may be quantum confined. In some embodiments, the nanoparticles 130 are pre-formed prior to being embedded in the host matrix 110. This pre-form process allows nanoparticles 130 to be fabricated to have particular shapes, sizes, composition, electrical properties, or the like, prior to being embedded within the host matrix 110. These pre-formed properties will be reflected in the operation of the NIP scintillator 101. While not intending to be limited by theory, the pre-formed properties may affect the emission wavelength peak of the emitted radiation caused by excitation of the nanoparticles 130 in the NIP scintillator 101. In some embodiments, the nanoparticles 130 comprise a maximum cross-sectional dimension in a range of from 1 nm to 100 nm, such as from 1 nm to 50 nm, 1 nm to 25 nm, 1 nm to 20 nm, 2 nm to 25 nm, 1 nm to 10 nm, 2 nm to 10 nm, 1 nm to 5 nm, 2 nm to 5 nm, or the like.

The nanoparticles 130 may comprise an oxide, perovskite, noble metal, or semiconductor material. In certain cases, but in a non-limiting manner, the nanoparticles 130 may comprise PbS, PbSe, PbTe, PbSSe, PbSeTe, CdS, CdSe, CdTe, CdSSe, CdSeTe, ZnS, ZnSe, ZnTe, ZnO, InAs, InSb, InP, InGaAs, CuInS₂, CuInSe₂, CuInSSe, CuInP, CuO, CuO₂, TiO₂, SnS, SnSe, SnTe, SnSSe, SnSeTe, SnO₂, Si, Ge, HgTe, FeO, GaAs, GaN, GaP GaSb, GaPAs, Bi₂S₃, Bi₂Se₃, or Bi₂Te₃, and includes any combinations, alloyed compositions, or core-shell structured permutations of nanoparticle materials. In some embodiments, the nanoparticles 130 comprise lead chalcogenide (PbX, where X is a chalcogenide such as S or Se). In some embodiments, these PbX nanoparticles 130 are embedded in a methylammonium lead halide or cesium lead halide perovskite polycrystalline host material 110. In one example implementation, PbS nanoparticles 130 may be configured such that the emission wavelength peak is between 1200 nm and 1300 nm, such as between 1200 nm to 1250 nm, for example, 1225 nm.

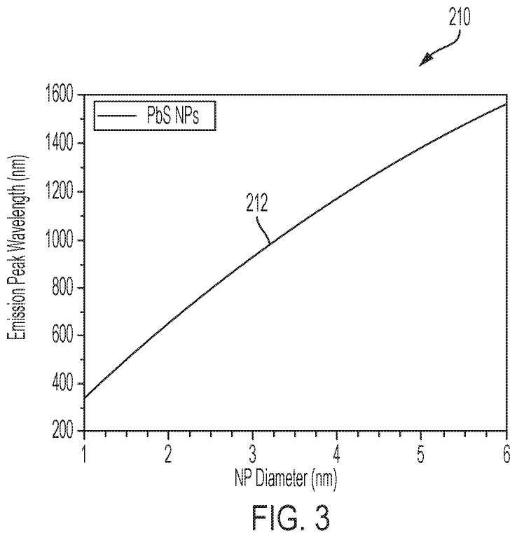

The peak emission wavelength can be tuned based on the properties of the nanoparticles 130 embedded in the host matrix 110. Without intending to be limited by theory, by utilizing nanoparticles 130 as emission centers in a host matrix 110 comprising a perovskite material, the peak emission wavelength can be tuned as desired, due to the size and composition-dependent optical properties of the nanoparticles 130, which allows for optimization of the detection efficiency of the emitted photons (e.g., the scintillated radiation 12). In some embodiments, the luminescent response (i.e., the scintillated radiation 12) to ionizing radiation 10 comprises an emission peak wavelength of from 300 nm to 1500 nm. The maximum cross-sectional dimension (e.g., diameter) of the one or more nanoparticles 130 is one tunable feature that affects the emission peak wavelength of the scintillated radiation 12. In FIG. 3, a graph 210 depicts emission peak wavelength as a function of diameter for PbS nanoparticles 130 embedded in the host matrix 110 of the NIP scintillator 101. As shown by line 212 of graph 210, increasing the diameter of the PbS nanoparticles increases the emission peak wavelength of the scintillated radiation 12.

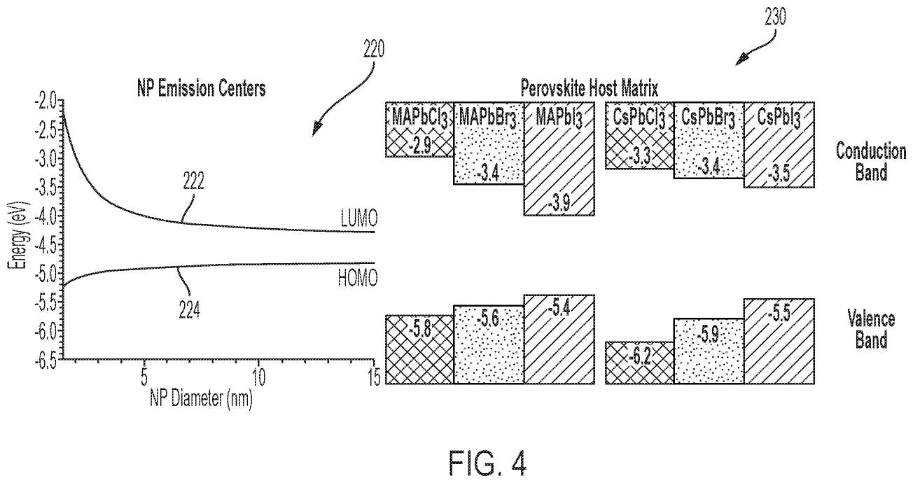

Referring now to FIG. 4, the nanoparticles 130 and the host matrix 110 may be tuned such that there is band alignment between the nanoparticles 130 and the host matrix 110. In particular, graph 220 of FIG. 4 shows the LUMO (lowest unoccupied molecule orbital) energy of PbS nanoparticles (line 222) and the HOMO (highest occupied molecule orbital) energy of NPS nanoparticles (line 224) as a function of their diameter and chart 230 depicts the conduction band and the valance band of example polycrystalline perovskite host matrixes comprising methylammonium lead halides or cesium lead halides. As shown by graph 220 and chart 230, the diameter of the nanoparticles may be selected such that both their LUMO energy and HOMO energy is within the bandgap of the host matrix 110. Without intending to be limited by theory, this type I band energy alignment between the nanoparticles 130 and the host matrix 110 facilitates propagation of photo-generated charges 122, 124 formed at an absorption event 120 in the host matrix 110 toward the nanoparticles 130, where they radiatively combine to generate scintillated radiation 12.

Without intending to be limited by theory, using nanoparticles 130 as emission centers in the host matrix 110 alleviates the explicit need for single crystal scintillator materials while maintaining the performance characteristics of such materials. Nanoparticles 130 have higher quantum yields (QY) than the pure material of the host matrix 110 and embedding the nanoparticles 130 in the host matrix 110 increases the brightness and efficiency of the NIP scintillator 101. Nanoparticles 130 allow for the peak photo luminescent (PL) emission wavelength to be modulated over a wide range such that it can be optimized to fall within the optimal efficiency ranges of several photodetectors 152.

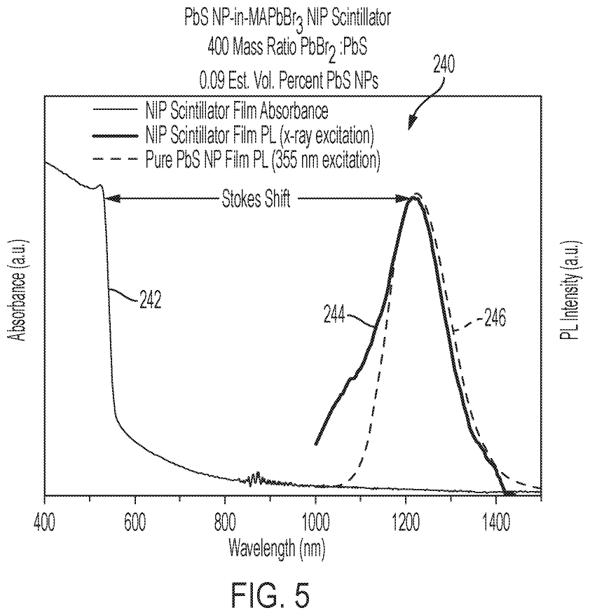

In addition, the nanoparticles 130 may minimize the optical reabsorption of the scintillated radiation 12 by the host matrix 10 by modulating the PL peak emission such that there is a large Stokes shift between the absorption and emission properties of the NIP scintillator 101. This is graphically depicted in FIG. 5, which shows absorbance and photo-luminescent intensity as a function of wavelength for an embodiment of the NIP scintillator 101 comprising MAPbBr₃ as the host matrix 110 and PbS as the nanoparticles 130. In particular, graph 240 shows absorbance wavelengths of the NIP scintillator 101 in line 242, the PL intensity of the emission wavelengths of the NIP scintillator 101 in response to x-ray excitation in line 244, and the PL intensity of the emission wavelengths of a film of pure nanoparticles in response to x-ray excitation in line 246. FIG. 5 also shows the Stokes shift between the absorption and the peak emission. With this Stokes shift, there is little to no overlap between the absorption and emission wavelengths. By increasing the Stokes shift, the host matrix 110 acts as a waveguide for the emitted light and there is minimal reabsorption of the emitted photons, thereby improving the performance by reducing reabsorption losses.

Furthermore, the nanoparticles 130 may be embedded in the host matrix 110 at a loading volume of from 0.001% to about 80% of the NIP scintillator 101, for example, from 0.01% to 50%, from 0.01% to 30%, from 0.01% to 25%, from 0.01% to 20%, from 0.01% to 15%, from 0.01% to 10%, from 0.01% to 5%, from 0.01% to 2%, from 0.01% to 1%, from 0.01% to 0.5%, from 0.01% to 0.25%, or the like. For example, the nanoparticles 130 may be embedded in the host matrix 110 at a loading volume of 80% or less, 50% or less, 30% or less, 25% or less, 20% or less, 15% or less, 10% or less, 5% or less, 2% or less, 1% or less, 0.5% or less, 0.25% or less, 0.2% or less, 0.15% or less, 0.1% or less, 0.075% or less. 0.05% or less, 0.025% or less, 0.02% or less, 0.01% or less, or the like.

Without intending to be limited by theory, as the thickness of the NIP scintillator 101 is increased, reducing the loading volume of the nanoparticles 130 may increase the luminescence intensity of the scintillated radiation 12 emitted by the NIP scintillator 101, but the correlation between the loading volume of the nanoparticles 130 and luminescent intensity is not linear. This non-linearity is due to a trade-off between two phenomena. First, increased loading volume of the nanoparticles 130 leads to improved charge carrier injection from the host matrix 110 into the nanoparticles 130, which leads to more scintillated radiation 12 exiting the NIP scintillator 101, and therefore a brighter response. However, increased loading volume of the nanoparticles 130 also increases the number of photons emitted by the nanoparticles 130 that are prevented from exiting the NIP scintillator 101 due to coupling-induced quenching and nanoparticle self-absorption. Nanoparticle self-absorption occurs when the absorption and emission spectra overlap causing emitted photons to be self-absorbed and converted back into individual charge carriers (e.g., when the Stokes shift is not large enough to reduce or eliminate this overlap). Both coupling-induced quenching and nanoparticle self-absorption reduce the number of overall photons emitted from the material. While these phenomena create additional factors to determining the amount of scintillated radiation 12 the NIP scintillator 101 is configured to emit, in general, reducing the loading volume of nanoparticles 130 as the thickness of the host matrix 110 increases will increase the luminescence of the scintillated radiation 12 emitted from the NIP scintillator 101. To balance these phenomenon, the loading volume may comprise 2% or less, for example, 1% or less. However, it should be understood that greater loading volumes are still contemplated.

In some embodiments the NIP scintillator 101 is formed using a powder pressing technique, in particular, by applying pressure to a composite powder mixture that incudes polycrystalline perovskite powder mixed with nanoparticle powder, for example using a mechanical hydraulic press. Pressure may be applied as part of a sintering process or hot isostatic pressing process. This processing method will produce a variety of shapes and sizes, including but not limited to large-area forms and wafers, increasing the applications of the NIP scintillator 101.

In some embodiments, the composite powder mixture is formed by dispersing a nanoparticle precursor in a perovskite precursor solution via a ligand exchange process during which the perovskite precursor species colloidally stabilize the nanoparticles in a single precursor solution. The single precursor solution is processed to produce the composite powder mixture that incudes polycrystalline perovskite powder mixed with nanoparticle powder, which may be pressed into the NIP scintillator 101. The loading and dispersion of nanoparticles in the host matrix is controllable by adjusting the concentration adjustments of the nanoparticle precursor and the perovskite precursor.

In some embodiments, the nanoparticle precursor is formed using a hot injection method. For example, for PbS nanoparticles, a sulfur-containing precursor solution is injected into a heated Pb-containing solution before being dispersed as a colloidal solution in a non-polar solvent. Hot injection produces nanoparticles with a high degree of monodispersity and allows for excellent control over the final size, and therefore optical properties, of the nanoparticles. For the perovskite precursor, the constitute component precursors (e.g., MA, Pb, and X) are solubilized in a polar solvent. Once the precursors are solubilized, the nanoparticles, in the non-polar solvent, can be added (e.g., via a facile ligand exchange process) to the perovskite precursor solution in the desired ratio to control the final loading volume of nanoparticles in the NIP scintillator and form a single, homogenous precursor solution. The precursor solution mixture is then subjected to conditions that are suitable for inducing the formation and growth of a polycrystalline scintillator material, such as a polycrystalline powder (e.g., the composite powder mixture). As noted above, the composite powder mixture may then be pressed into pellets/wafers, or other desired shapes and sizes, and may or may not be heated to fully sinter the powder into a solid piece of the desired shape and/or size.

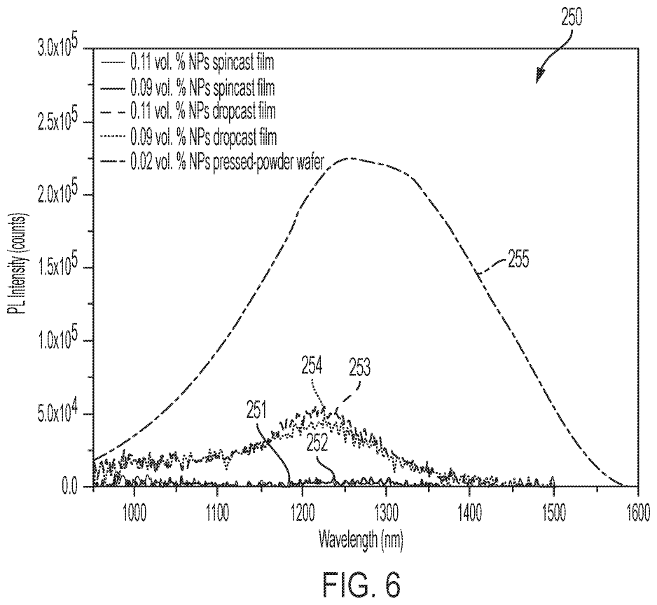

By using a pressed powder technique, the NIP scintillator 101 may be formed into a thickness of 1 mm or greater. This increased thickness facilitates the absorption of ionizing radiation 10 having increased photon energy, as described above with respect to FIG. 2. When compared to other methods of forming scintillators, such as spin casting and drop casting techniques, this technique forms NIP scintillators with a capacity to absorb higher photon energy radiation. For example, FIG. 6 graphically depicts photo-luminescent intensity of scintillating radiation as a function of wavelength for NIP scintillators forming using a spin casting techniques, drop casting techniques, and powder pressing techniques that are irradiated with ionizing radiation having a photon energy of 5.9 keV. In particular, line 251 depicts photo-luminescent intensity as a function of wavelength of an NIP scintillator having a nanoparticle loading volume of 0.11% formed using a spin casting technique, line 252 depicts photo-luminescent intensity as a function of wavelength of an NIP scintillator having a nanoparticle loading volume of 0.09% formed using a spin casting technique, line 253 depicts photo-luminescent intensity as a function of wavelength of an NIP scintillator having a nanoparticle loading volume of 0.11% formed using a drop cast technique, line 254 depicts photo-luminescent intensity as a function of wavelength of an NIP scintillator having a nanoparticle loading volume of 0.09% formed using a drop cast technique, and line 255 depicts photo-luminescent intensity as a function of wavelength of an NIP scintillator having a nanoparticle loading volume of 0.02% formed using a pressed powder technique.

Referring still to FIG. 6, lines 251 and 252 show that the NIP scintillator samples formed using spin casting were unable to produce any luminescent response to 5.9 keV ionizing radiation and lines 253 and 254 show that NIP scintillator samples formed using drop casting were only able to produce a weak luminescent response to 5.9 keV ionizing radiation. In contrast, line 255 shows that the pressed powder technique can be used to form an NIP scintillator having a luminescent response over 4 times as bright in peak intensity as the drop cast scintillators. To achieve this luminescent response, the example NIP scintillator of line 255 is 16 mm thick, which is not achievable using a spin casting or drop casting technique but is readily achievable using the pressed powder technique described above.

Referring again to FIG. 1, the one or more photodetectors 152 may be optically coupled to the second surface 114 of the NIP scintillator 101 and may be arranged in a photodetector array 150. The one or more photodetectors 152 may comprise any optical detectors configured to detect one or more photons, such as a charged coupled device (CCD), a photodiode, a photomultiplier tube (PMT), a light detector pixel, a spectrometer, a nanowire single photon detector, or any other detector capable of detecting ultra violet, visible, or near-infrared light. While the photodetectors 152 are depicted in direct contact with the NIP scintillator 101 in FIG. 1, in some embodiments, the photodetectors 152 may be spaced apart from the NIP scintillator 101 and optically coupled through and/or using one or more optical components. For example, one or more optical fibers may extend between and optically coupled the NIP scintillator 101 (e.g., the second surface 114 of the NIP scintillator 101) with the one or more photodetectors 152.

While not depicted, the scintillator system 100 may further include a processor communicatively coupled to the one or more photodetectors 152 for measuring the luminescent response of the NIP scintillator 101 and converting the measurement into information about the ionizing radiation received by the host matrix 110. Indeed, the light emitted by the nanoparticles 130 is collected by the one or more photodetectors 152 and converted into an electrical signal. In addition calibration data can be created relating the NIP scintillator luminescent response to dose and/or energy of impinging radiation, which may be used to identify and quantify the amount of incident radiation impinging upon the NIP scintillator 101. In some embodiments, the scintillator system 100 may be communicatively coupled to a communication device/interface allowing for the transmission of information to a remote location, such as measurement information, impinging radiation information, location information, and device identification information. Locational information may be obtained through and/or transmitted as geographic coordinates (e.g. coordinates from a GPS unit) or a Cell ID (e.g. information from a cellular network) or using the identifier of the device to infer a location.

The scintillator system 100 may be incorporated into a variety of implementations. As one example, the scintillator system 100 includes a high-resolution screen that can be made of material of the NIP scintillator 101 and may be optically coupled an array of individually coupled light detector pixels (that form the photodetector array 150). In this embodiment, the sub-pixel size of the nanoparticles 130 (which operate as emission centers) in the NIP scintillator 101 reduces the number of cross-pixel signals, thereby reducing blurring and increasing contrast in the high-resolution image. In a specific embodiment of this implementation, the use of MAPbBr₃ perovskite as the host matrix 110 and principle radiation absorber material allows the thickness of the NIP scintillator 101 (i.e., the thickness of the high-resolution screen) to be reduced, further reducing the pixel cross-signals and further reducing blurring and increasing resolution further.

As another example, the scintillator system 100 may be a dosimeter for measuring exposure to ionizing radiation. For example, the one or more photodetectors 152 may be connected to a processor such that the output signal is configured to relate the dose and may be configured to sound an alarm when a radiation event exceeds a specified threshold. The dosimeter may be portable and may be coupled to the low-power processor and/or display unit such that a user coupled measure radiation dose at the location of a radiation event. Further, the scintillator system 100 may comprise multiple scintillator materials, including at least one NIP scintillator 101. By including multiple scintillator materials, the scintillator system 100 may identify radiation using materials having different stimulation and peak emission wavelengths. In this embodiment, a multi-channel analyzer may be used to separate and determine the properties of the impinging ionizing radiation. This multi scintillator embodiment may be incorporated into the portable dosimeter implementation.

In some further embodiments, the NIP scintillator 101 may be coupled to an energy generation device instead of a photodetector 152, thereby utilizing the emission light to generate electricity using the energy generation device. For example, this may include optically coupling the NIP scintillator 101 to a solar cell. Further, the peak emission wavelength of the one or more nanoparticles 130 may be manipulated correspond with the conversion efficiency of the energy generation device.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A nanoparticle-in-perovskite (NIP) scintillator comprising a host matrix and one or more nanoparticles embedded in the host matrix; wherein:
the one or more nanoparticles are embedded in the host matrix at a loading volume of 20% or less;
the host matrix comprises a thickness of 1 mm or greater;
the host matrix comprises a polycrystalline perovskite material; and
the NIP scintillator is configured to exhibit a luminescent response to ionizing radiation comprising a photon energy of 1 keV or greater.

2. The NIP scintillator of claim 1, wherein the polycrystalline perovskite material of the host matrix comprises A₂MX₄, AMX₃, ANX₄, or BMX₄, wherein:
A is a monovalent cation, or a combination of monovalent cations, comprising Li, Na, K, Rb, Cs, Fr, organic amidine compounds, or primary, secondary, tertiary, or quaternary organic ammonium compounds comprising 1 to 15 carbons;
B is a divalent cation, or a combination of divalent cations, comprising Mg, Co, Ca, Cd, Sr, Ba, organic amidine compounds, or primary, secondary, tertiary, or quaternary organic ammonium compounds comprising 1 to 15 carbons,
M is a divalent metal cation, or a combination of divalent metal cations, comprising Pb, Sn, Cu, Ni, Co, Fe, Pd, Cd, Eu, Yb, or Ge,
N is Bi, Sb, or a combination thereof, and
X is a monovalent anion, or a combination of monovalent anions, comprising F, Cl, Br, I, SCN, CN, OCN, or BaF₄.

3. The NIP scintillator of claim 1, wherein the NIP scintillator is configured to exhibit a luminescent response to ionizing radiation comprising a photon energy of 10² keV or greater.

4. The NIP scintillator of claim 1, wherein the host matrix comprises a thickness of 1 cm or greater.

5. The NIP scintillator of claim 1, wherein the one or more nanoparticles comprises at least one of PbS, PbSe, PbTe, PbSSe, PbSeTe, CdS, CdSe, CdTe, CdSSe, CdSeTe, ZnS, ZnSe, ZnTe, ZnO, InAs, InSb, InP, InGaAs, CuInS₂, CuInSe₂, CuInSSe, CuInP, CuO, CuO₂, TiO₂, SnS, SnSe, SnTe, SnSSe, SnSeTe, SnO₂, Si, Ge, HgTe, FeO, GaAs, GaN, GaP GaSb, GaPAs, Bi₂S₃, Bi₂Se₃, and Bi₂Te₃.

6. The NIP scintillator of claim 1, wherein the one or more nanoparticles comprise PbX, where X comprises a chalcogenide.

7. The NIP scintillator of claim 1, wherein the polycrystalline perovskite material of the host matrix comprises a methylammonium lead halide comprising MAPbCl₃, MAPbI₃, or MAPbBr₃.

8. The NIP scintillator of claim 1, wherein the polycrystalline perovskite material of the host matrix comprises a cesium lead halide comprising CsPbCl₃, CsPbI₃, or CsPbBr₃.

9. The NIP scintillator of claim 1, wherein:
the one or more nanoparticles comprise a maximum cross-sectional dimension in a range of from 2 nm to 10 nm; and
the one or more nanoparticles are embedded in the host matrix at a loading volume of 2% or less.

10. NIP scintillator of claim 1, wherein:
the luminescent response to ionizing radiation comprises an emission peak wavelength of from 300 nm to 1500 nm; and
the luminescent response to ionizing radiation comprises a scintillation efficiency of 1% or greater.

11. A method of manufacturing a nanoparticle-in-perovskite (NIP) scintillator, the method comprising applying pressure to a composite powder mixture comprising polycrystalline perovskite powder mixed with nanoparticle powder thereby pressing the composite powder mixture into a wafer having a thickness of 1 mm or greater, the wafer comprising a host matrix of polycrystalline perovskite material having one or more nanoparticles embedded in the host matrix at a loading volume of 20% or less.

12. The method of claim 11, further comprising dispersing a nanoparticle precursor in a perovskite precursor solution via a ligand exchange process to form the composite powder mixture prior to applying pressure to the composite powder mixture.

13. The method of claim 12, wherein the nanoparticle precursor is formed by a hot injection method.

14. The method of claim 12, wherein the thickness of the wafer is 1 cm or greater.

15. The method of claim 12, wherein the NIP scintillator is configured to exhibit a luminescent response to electromagnetic radiation comprising a photon energy of 1 keV or greater.

16. The method of claim 12, wherein:
the polycrystalline perovskite material of the host matrix comprises a methylammonium lead halide or a cesium lead halide; and
the one or more nanoparticles comprise PbX, where X comprises a chalcogenide.

17. A method of outputting scintillated radiation, the method comprising:
receiving ionizing radiation comprising a photon energy of 1 keV or greater using an NIP scintillator comprising one or more nanoparticles embedded in a host matrix at a loading volume of 20% or less, the host matrix comprising polycrystalline perovskite;
absorbing the ionizing radiation in the host matrix thereby inducing emission of scintillated radiation from at least one of the one or more nanoparticles; and
outputting scintillated radiation from the NIP scintillator comprising a scintillation efficiency of 1% or greater.

18. The method of claim 17, wherein the host matrix comprises a thickness of 1 cm or greater.

19. The method of claim 17, wherein the ionizing radiation comprises a photon energy of 10² keV or greater.

20. The method of claim 17, wherein:
the polycrystalline perovskite material of the host matrix comprises a methylammonium lead halide or a cesium lead halide; and
the one or more nanoparticles comprise PbX, where X comprises a chalcogenide.
